(19) United States
(12) Patent Application Publication
(10) Pub. No.: US 2026/0172721 A1
(43) Pub. Date: Jun. 18, 2026

(54) Image Sensor with Reconfigurable Retinal Processing

(71) Applicants: Wisconsin Alumni Research Foundation, Madison, WI (US); George Mason University, Fairfax, VA (US)

(72) Inventors: Akhilesh Jaiswal, Madison, WI (US); Md Abdullah-Al Kaiser, Irvine, CA (US); Jason Sinaga, Madison, WI (US); Maryam Parsa, Fairfax, VA (US); Maria Victoria Clerico, Zürich (CH); Shay Snyder, Bluff City, TN (US); Gregory Schwartz, Chicago, IL (US)

(21) Appl. No.: 19/417,561

(22) Filed: Dec. 12, 2025

Related U.S. Application Data
(60) Provisional application No. 63/733,491, filed on Dec. 13, 2024.

(51) Int. Cl. H04N 25/78; H04N 25/46; H04N 25/771; H04N 25/79

(52) U.S. Cl. CPC H04N 25/78; H04N 25/46; H04N 25/771; H04N 25/79

(57) ABSTRACT

An imaging system providing object motion preprocessing allows a switchable division of signals from different pixels into groups of center and surround pixels of arbitrary shapes and positions allowing tailoring of motion detection to particular objects whose motion should be identified, for example, using smaller center regions for smaller objects.

### CROSS REFERENCE TO RELATED APPLICATION

This application claims the benefit of U.S. Provisional Application 63/733,491 filed Dec. 13, 2024, and hereby incorporated by reference.

### STATEMENT REGARDING FEDERALLY SPONSORED RESEARCH OR DEVELOPMENT

This invention was made with government support under 2319617 and 2319619 awarded by the National Science Foundation. The government has certain rights in the invention.

### BACKGROUND OF THE INVENTION

The present invention relates generally to image sensing circuits and, in particular, to an image sensing circuit providing flexible pre-processing of object motion.

Traditional cameras, such as CMOS active pixel sensors and charge coupled devices, rely on frame-based capture where the entire scene is captured at a fixed rate. This frame-based capture can lead to excessive computation and bandwidth requirements when communicating image data with subsequent image processing circuitry.

Recent advances in retinal neuroscience have led to a more detailed understanding of the biological circuits responsible for generating fundamental visual features. This in turn has driven the development of image sensors that can perform a preprocessing of image data prior to transmission reducing the need for later computation and the problems of bandwidth limitation in the transmission of unprocessed image data.

Recently, Integrated Retinal Functionality in Image Sensors (IRIS) have been developed to imitate complete retinal computations for object motion detection by dividing the pixel sensors into center and surround regions in the image sensing circuit. Abrupt motion between the center region and surround region causes a charge to be injected or withdrawn from a node producing node voltages that indicate motion. This motion information can be used to help in optical tracking, optical flow estimation, and a variety of other common image processing tasks.

### SUMMARY OF THE INVENTION

The present inventors have recognized that the ability to dynamically adjust the center and surround regions in the imaging hardware can permit more sophisticated processing, for example, motion sensing, tailored to the size of objects in the image field. The invention thus provides a way of dynamically reconfiguring the pixel sensors into center and surround regions (or multiple center and surround regions). Important in some embodiments, this further provides an ability to manage different signal levels caused by changes in sensor grouping and a practical implementation in circuitry including a way of managing variable leakage currents.

More specifically, in one embodiment, the invention provides an image sensor having an array of electrical photo sensors and a switch network. The switch network receives switch control signals and sensing signals derived from the electrical photo sensors and operates according to the switch control signals to variably divide the sensing signals into center sensing signals from photo sensors of a center region and surround sensing signals from photo sensors of a region surrounding the center region. A comparison circuit then provides a comparison output representing a comparison of the combined signals from the center region and the combined signals from the surround region.

It is thus a feature of at least one embodiment of the invention to provide an image sensor that can dynamically adjust the size and/or location of center and surround regions of pixels for flexible motion assessment.

The comparison circuit may further receive a comparison threshold signal controlling a threshold of the comparison circuit according to the comparison threshold signal.

It is thus a feature of at least one embodiment of the invention to provide more consistent motion analysis by accommodating changes in relative size of center and surround regions through offsetting comparison adjustments.

The electrical photo sensors may be divided into cells each having an independent switch network and may further include transmission gates controllable to selectively combine center sensing signals and surround sensing signals from different adjacent cells.

It is thus a feature of at least one embodiment of the invention to exploit the fact that the center region and surround regions are contiguous pixels to provide a simple method of aggregating photosensor outputs into arbitrarily sized and or located center regions and surround regions without a complex multiway switch network.

The electrical photo sensors may be divided into cells each having an independent switch network and further having a memory circuit associated with each cell persistently holding switch control signals for the cell.

It is thus a feature of at least one embodiment of the invention to allow for the dynamic adjustment of the center and surrounding regions while minimizing interconnects between the cells, for example, to the use of an addressable bus structure and local memory.

The memory circuit may include a logical configuration file receiving one of a set of configuration numbers to provide switch control signals for the cell according to the configuration number within the set.

It is thus a feature of at least one embodiment of the invention to allow rapid dynamic switching between predefined states of center regions and surround regions with reduced interconnect and bandwidth requirements.

The image sensor may further include a current gate controllable according to a leakage current signal to conduct a leakage current offset amount to or from the node as a function of the control signals.

It is thus a feature of at least one embodiment of the invention to provide a practical circuit that can accommodate finite leakage currents of the transistors and offset variations in leakage current attendant to changing center and surround region size.

These particular objects and advantages may apply to only some embodiments falling within the claims and thus do not define the scope of the invention.

### BRIEF DESCRIPTION OF THE DRAWINGS

FIG. 1 is an exploded diagram of an image sensor according to the present invention showing different processing layers including a photosensor layer, a bipolar layer, and a switching network layer, and further showing, in expanded views, the grouping of pixels into cells and the aggregation of cells into center and surround regions of multiple pixel elements;

FIG. 2 is a schematic representation of switch networks of the switching network layer such as connect at a node to a comparator associated with multiple pixel elements;

FIG. 3 is a schematic representation of one embodiment of the comparator FIG. 2;

FIG. 4 is a block diagram of multiple pixel elements within a cell and intercommunication between nodes of the cells to define larger center and surround regions; and

FIG. 5 is a logical representation of a memory associated with pixel elements and operating to simplify interconnections and minimize network bandwidth.

### DETAILED DESCRIPTION OF THE PREFERRED EMBODIMENT

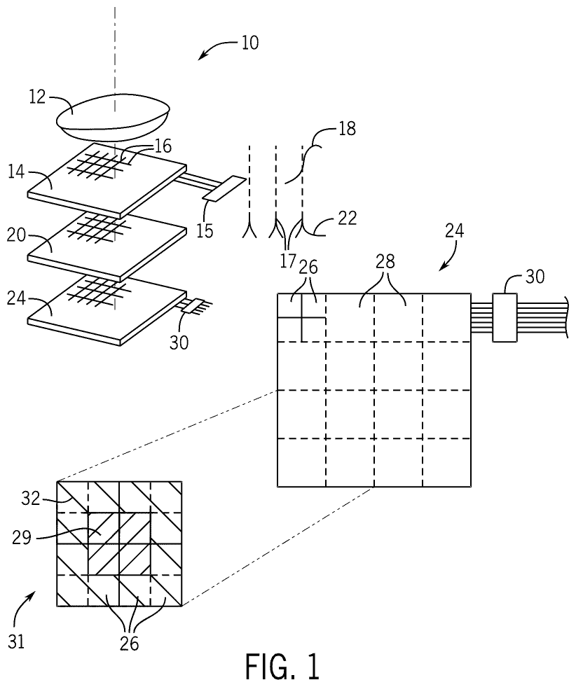

Referring now to FIG. 1, an electronic imaging system 10 may provide for a lens system 12 focusing an image on a sensor array 14 of photo sensors each providing a pixel element 16 arranged, for example, at a regular spacing over an imaging area. As is generally understood in the art, each of the pixel elements 16 may provide for a luminance signal 18 that varies with time according to intensity of the projected image at that pixel element, a variation, for example, caused by motion of objects within the field-of-view. In one embodiment, the sensor array 14 may be a CMOS sensor array using frame-based capture with luminance signals 18 from each pixel element 16 transmitted to an image processor 15 or the like for image reconstruction, processing, and display.

The luminance signals 18 may also be provided to a bipolar circuit layer 20 of a type known in the art and generating for each pixel element 16 bipolar signals 22 based on changes in the luminance signal 18 of the pixel element 16. Bipolar signals 22 may approximate a differentiation of the luminance signal 18 at a given pixel element 16, thus being sensitive to changes in the luminance signal 18 albeit only with positive going pulses 17.

The bipolar signals 22 are next provided to an object motion circuit 24 sensitive to motion deduced from signals from pixel elements 18. In this regard, the object motion circuit 24 may include multiple switch elements 26 each receiving one bipolar signal 22 from one pixel element 16 in a one-to-one relationship. In operation, the object motion circuit 24 uses the switch elements 26 to define a center region 29 of pixel elements 18 and a surround region 32 of pixel elements 18 surrounding that center region in the sensing region 31. The object motion circuit 24 then compares the bipolar signals 22 of these two different regions 29 and 32 and provides this comparison signal to a control circuit 30 for further processing. The operation of the object motion circuit 24 greatly reduces the bandwidth necessary to transmit this motion information and later processing demands required for analyzing motion.

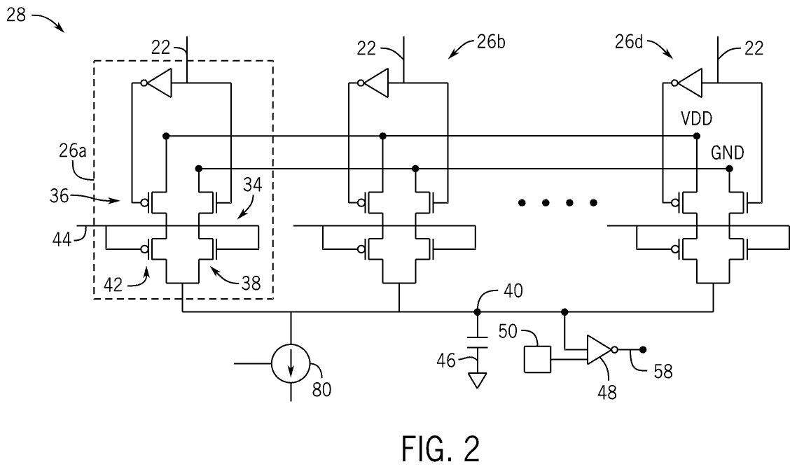

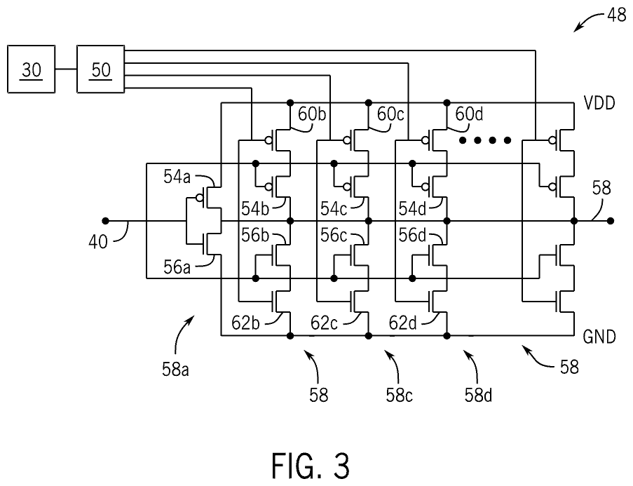

Referring now also to FIG. 2, each switch element 26 may receive a bipolar signal 22 from a pixel element 16 via the bipolar circuit layer 20 and a center/surround signal 44 from the control circuit 30. This bipolar signal 22 is provided to the gate of an NMOS transistor 34, and an inversion of the bipolar signal 22 is provided to the gate of the PMOS transistor 36. One leg of the PMOS transistor 36 (drain) is connected to a positive voltage (VDD), and one leg of the NMOS transistor 34 (source) is connected to ground. Each of the NMOS transistor 34 and PMOS transistor 36 has complementary switching action and, accordingly, current may flow in only one or the other of the PMOS transistor 36 and NMOS transistor 34 depending on the bipolar signal 22.

The NMOS transistor 34 is connected in series with a second NMOS transistor 38 which in turn connects to a common node 40. Similarly, the PMOS transistor is connected in series with a second PMOS transistor 42 which in turn also connects with the common node 40. The gates of the NMOS transistor 38 and PMOS transistor 42 are controlled by a center/surround signal 44 providing that only one of them may conduct current depending on the state of the center/surround signal 44.

Multiple switch elements 26 may be grouped together within a cell 28, shown in FIG. 2 for simplicity as comprised of four switch elements 26. Each of the switch elements 26 within a cell communicates with a common node 40. As so connected, the center/surround signal 44 associated with each switch element will cause either an injection of current into the node 40 upon the occurrence of a pulse 17 of the bipolar signal 22 (through PMOS transistors 36 and 42) or an extraction of current from the node 40 upon occurrence of a pulse 17 of the bipolar signal 22 (through NMOS transistors 34 and 38). This routing determines whether the bipolar signal 22 (and hence the pixel element 18) of that switch element will be associated with either the center region 29 or surround region 32, the summing of currents into and out of node 40 thus providing a comparison of the dominance of bipolar signals 22 from each of these regions.

In this example, a positive voltage center/surround signal 44 causes a bipolar signal 22 to be manifested as a current drain from the node 40 denoting a center region 29, and a zero voltage center/surround signal 44 causes the bipolar signal 22 to be manifested as a current injection to the node 40 denoting a surround region 32.

It will thus be understood that the center/surround signals 44 from the control circuit 30 may flexibly define any pixel element 18 as a center pixel element 18 in region 29 or a surround pixel element 18 in region 32.

The node 40 of each cell 28 may in turn connect to an integrating capacitor 46 resulting in a voltage at an input of a comparator 48 dependent on an integrated net current flow into and out of the node 40. The comparator 48 may provide a variable threshold signal 50 as will be discussed below to produce an output voltage on output 59 indicating relative activity in the center region 29 and the surrounding regions 32 reflecting motion. For example, motion reflected in changes in luminance values at pixel elements 18 in the center region 29 will cause a decrease in the voltage at the node 40 tending to produce a low output 59 whereas motion in the surround region 32 will cause an increase in voltage at the node 40 which may be manifest as a high output 59. An object moving from a center region 29 to a surround region 32 may be manifested as a high output from the comparator 48 followed by a low output from the comparator 48 while an object moving from a surround region 32 to a center region 29 will be manifested has a low output from the comparator followed by a high output of the comparator 48.

Depending on the number of switch elements 26 associated with a center region 29 or surround region 32, the relative proportion of current flow to and from the node 40 may be significantly altered in a way that changes the relative weighting of motion in these different regions 29 and 32. This effect may be offset through the use of a comparator 48 that can offer different comparator thresholds according to a threshold signal 50.

Referring now to FIG. 5, an adjustable comparator 48 operating with a variable threshold for this purpose may receive a signal from node 40 at an input of an inverter circuit 58a consisting of series connected PMOS transistor 54a and NMOS transistor 56a in turn connected across a source of power and ground (VDD and GMD) to alternately conduct current to voltage output 59. The threshold signal 50 may be used to change the switching threshold of this comparator 48 by successively activating different ranks of similar inverter circuits 58b, 58c, 58d, 58e operating in parallel with the inverter circuit 58a. While only four additional ranks of inverter circuits are shown, it will be appreciated that this number may be arbitrarily varied according to the desired resolution of comparator threshold adjustment. The common components of these additional inverter circuits 58 will be described collectively using identifying numbers and depicted separately on the drawings with those numbers appended to letters a, b, c and d.

Each of the additional inverter circuits 58b onward also provides a PMOS transistor 54 and NMOS transistor 56 connected in series so that their junction also connects the output 59. The source terminal of the PMOS transistor 54 is connected to a positive voltage through gating PMOS transistor 60, and the drain terminal of the NMOS transistor 56 is connected to ground through gating NMOS transistor 62. The gates of transistors 60 and 62 receive a binary signal being part of the threshold signal 50 that is sequentially activated among the different inverter circuits 58 to progressively change the threshold of the comparator 48.

It will be appreciated that for each of the inverter circuits 58, activating the transistors 60 will increase the threshold voltage of the comparator 48 by slightly increasing the voltage on output 59 while activating the transistors 62 will slightly lower that threshold. Changes in the amount of threshold adjustment are implemented by increasing the number of activated inverter circuits 58.

As noted, the threshold signal 50 may be adjusted by the control circuit 30 according to the relative proportion of pixels in the center region 29 versus the surround region 32 or to generally increase the sensitivity of either of these regions, or to compensate for changes in the density of bipolar signal pulses 17 (lowering the threshold as density decreases) to increase the dynamic range of sensitivity of the circuit for a particular region.

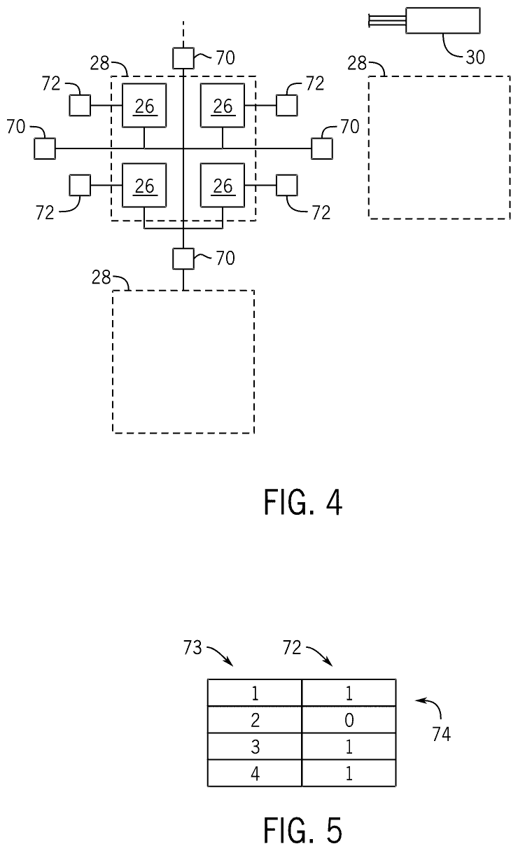

Referring now to FIG. 4, the nodes 40 of multiple switch elements 26 of a given cell 28 may be connected to the nodes 40 of cells 48 that are adjacent to the given cell 28 (to the left or right or up or down) by means of transmission gates 70. The transmission gates provide electrical connection between the nodes 40 allowing the cells 28 to be stitched together into arbitrarily sized sensing regions 31 under the control of the circuit 30. For this purpose, the control circuit 30 may receive programming information from the image processor 15 doing other signal processing for the imaging system 10. The use of the transmission gates 70 and the center/surround signals 44 allow arbitrary sizes and locations of center regions 29 and surround regions 32 to be developed or multiple flexibly spaced and sized center regions 29 and surround regions 32 to be developed with respect to the pixel elements 18 of the entire array.

When nodes 40 are joined by transmission gates 70 any of the associated comparators 48 may be used to define the output 59 for the combined elements as selected by the control circuit 30.

Referring still to FIG. 4, each of the switch elements 26 may be associated with a local memory 72 positioned on the object motion circuit 24 integrated circuit and ideally closely proximate to the switch elements 26. This local memory 72 may output the stored center/surround signals 44 needed by the switch elements 26 whose values may be loaded at an earlier time by the circuit 30. This loading, for example, may use a conventional multiplexed addressing that can operate with low bandwidth requirements compared to the extraction of image data. In some embodiments, each of the local memories 72 may implement a logical lookup table 74 that may receive from the control circuit 30 a state value 73 broadcast to all local memories 72 linked to a value of the center/surround signals 44 for the particular switching element 26. This allows every local memory 72 to be addressed in parallel to change the center/surround signals 44 in a manner tailored to each individual switching element 26 for high-speed response. As before, the logical lookup table 74 may be loaded prior to or independent of imaging through a lower bandwidth connection. The local memories may employ any of a variety of different memory technologies and may be volatile or nonvolatile, the latter case including memristors, flash memory, and the like.

Referring again to FIG. 2, the node 40 associated with each cell 28 may provide a current offset element 80 operating to source or sink a predetermined current from the node 40 for the purpose of compensating for transistor leakage in the transistors of the switch elements 26. The amount of current may be determined by the control circuit 30 and may be set, for example, at the time of manufacture according manufacturing variations, or dynamically according to temperature and/or the variation in transistor numbers between the center region 29 and surround region 32. Generally, the current offset element 80 may be implemented with a control current source such as a transistor or the like

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

References to “a microprocessor” and “a processor” or “the microprocessor” and “the processor,” can be understood to include one or more microprocessors that can communicate in a stand-alone and/or a distributed environment(s), and can thus be configured to communicate via wired or wireless communications with other processors, where such one or more processor can be configured to operate on one or more processor-controlled devices that can be similar or different devices. Furthermore, references to memory, unless otherwise specified, can include one or more processor-readable and accessible memory elements and/or components that can be internal to the processor-controlled device, external to the processor-controlled device, and can be accessed via a wired or wireless network.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications, are hereby incorporated herein by reference in their entireties

To aid the Patent Office and any readers of any patent issued on this application in interpreting the claims appended hereto, applicants wish to note that they do not intend any of the appended claims or claim elements to invoke 35 U.S.C. 112(f) unless the words “means for” or “step for” are explicitly used in the particular claim.

What we claim is:

1. An image sensor comprising:
an array of electrical photo sensors;
a switch network receiving switch control signals and sensing signals derived from the electrical photo sensors, the switch network operating according to the switch control signals to variably divide the sensing signals into center sensing signals from photo sensors of a center region and surround sensing signals from photo sensors of a surround region surrounding the center region; and
a comparison circuit providing a comparison output representing a comparison of combined signals from the center region and the combined signals from the surround region.

2. The image sensor of claim 1 wherein the comparison circuit further receives a comparison threshold signal controlling a threshold of the comparison circuit according to the comparison threshold signal.

3. The image sensor of claim 2 further including an image sensor control circuit changing the comparison threshold signal as a function of relative numbers of electrical photo sensors providing the center sensing signals and surround sensing signals.

4. The image sensor of claim 1 wherein the electrical photo sensors are divided into cells each having an independent switch network and further including transmission gates controllable to selectively combine center sensing signals and surround sensing signals from different adjacent cells.

5. The image sensor of claim 1 wherein the electrical photo sensors are divided into cells each having an independent switch network and further a memory circuit associated with each cell persistently holding switch control signals for the cell.

6. The image sensor of claim 5 wherein the memory circuit includes a logical configuration file receiving one of a set of configuration numbers to provide switch control signals for the cell according to the configuration number within the set.

7. The image sensor of claim 1 wherein the switch network includes first and second transistors connected to sink or source current from or to a node, the first and second transistors conducting according to sensing signals, and wherein the switch network selectively blocks current flow from one of the first and second transistors according to the control signals and whether an associated photosensor is designated as a center region or a surround region photosensor.

8. The image sensor of claim 7 wherein the switch network includes third and fourth transistors connected in series, respectfully, with the first and second transistors and communicating with the control signals to selectively block current flow from one of the first and second transistors.

9. The image sensor of claim 7 wherein the node communicates with a summing junction summing current conducted by the first and second transistors.

10. The image sensor of claim 9 wherein the summing junction integrates current conducted by the first and second transistors.

11. The image sensor of claim 7 further including a current gate controllable according to a leakage current signal to conduct a leakage current offset amount to or from the node as a function of the control signals.

12. The image sensor of claim 1 further including a bipolar circuit positioned between the photo sensors and the switch network providing a differentiation of a signal from the photo sensors to the switch network.

13. The image sensor of claim 1 wherein the array of electrical photo sensors are CMOS sensors.

14. The image sensor of claim 1 wherein the switch network and comparison circuit are implemented as NMOS and PMOS transistors.

15. A method of image signal processing in an image sensor of a type having an array of electrical photo sensors; a switch network receiving switch control signals and sensing signals derived from the electrical photo sensors, the switch network operating according to the switch control signals to variably divide the sensing signals into center sensing signals from photo sensors of a center region and surround sensing signals from photo sensors of a surround region surrounding the center region; and a comparison circuit providing a comparison output representing a comparison between the combined signals from the center region and the combined signals from the surround region, the method comprising:
(a) monitoring an image from the electrical photo sensors; and
(b) according to the monitoring, changing the control signals to change a division of the sensing signals into center sensing signals and surround sensing signals.
